(19) United States
(12) Patent Application Publication
(10) Pub. No.: US 2008/0096758 A1
(43) Pub. Date: Apr. 24, 2008

(54) Low-thermal expansion ceramics bonding body and manufacturing method of the same

(75) Inventors: Hiroto Unno, Tokyo (JP); Jun Sugawara, Tokyo (JP)

Correspondence Address: OLIFF & BERRIDGE, PLC, P.O. BOX 320850, ALEXANDRIA, VA, 22320-4850, US

(73) Assignees: NIPPON STEEL MATERIALS CO., LTD., TOKYO (JP); KROSAKI HARIMA CORPORATION, KITAKYUSHU-SHI (JP)

(21) Appl. No.: 11/819,101

(22) Filed: Jun. 25, 2007

(30) Foreign Application Priority Data
Jun. 27, 2006 (JP) 2006-176966

(51) Int. Cl. C04B 33/00; B32B 37/06

(52) U.S. Cl. 501/141; 156/60

(57) ABSTRACT

A bonded body obtained by unifying a plurality of structural members exhibiting 0.6*10⁻⁶/K or less of absolute value of thermal expansion coefficient in room temperature, 100 GPa or more of modulus of elasticity and 40 GPa·cm³/g or more of specific rigidity, the plurality of structural members having bonding surfaces that are brought into contact with each other and are unified by a heating process, and a manufacturing method thereof are provided. The sintered block contains 51.5 to 70.0 oxide-equivalent mass % of Si, the oxide-equivalent mass % being calculated as a ratio of Si in elements (Mg, Al and Si) constituting the sintered block on oxide (MgO, Al₂O₃, SiO₂) basis. Surplus SiO₂ residing in the sintered block forms a liquid phase during the heating process to activate mass transfer, so that the material of the bonded portion becomes substantially the same as the base material. Residual stress on account of difference in thermal expansion coefficient can be eliminated and a bonded body with extremely high bonding strength can be obtained.

### BACKGROUND OF THE INVENTION

1. Field of the Invention

The present invention relates to a low-thermal expansion ceramics bonded body manifesting very small thermal expansion at room temperature and abounding in rigidity and specific rigidity for the use in members including production units and measurement units of semiconductors, magnetic heads and the like, and to a method for the production thereof.

2. Description of Related Art

Recently, owing to the trend of semiconductors toward higher integration and magnetic heads toward further miniaturization, the production units (such as a lithography stepper, a processing machine and an assembly machine) and the measurement units for such semiconductors and the magnetic heads have reached the point of requiring high dimensional accuracy and high rigidity. For these devices, the stability of dimensional and geometric accuracy has also come to gain in significance. The prevention of such devices from incurring the deformation which is caused by the fluctuation of an ambient temperature or the emission of heat from the device itself has become an important task. The materials which produce very small thermal expansion and abound in rigidity and specific rigidity (Young's modulus/bulk density) have come to find the use for component members in such devices.

Document 1 (JP11-74334A), Document 2 (JP2001-19540A) and Document 3 (JP2004-292249A) show a sintered block primarily containing cordierite (2MgO.2Al₂O₃.5SiO₂) or lithium aluminosilicate (Li₂O—Al₂O₃—SiO₂)) that is used as the structural members of the devices.

However, more lightweight structural member is recently in demand in accordance with further increase in size and movement speed of the devices. In order to reduce the weight of the structural member, a hollow-structural member is employed. Specifically, a hollow box-shaped structural member or a member having a reinforcing rib bonded inside the hollow box-shaped structural member is provided to acquire an internal space, thereby considerably reducing the weight of the structural member of the device.

While ceramics have high strength and high rigidity, the shape of the ceramic products is much restricted and manufacturing cost is high due to the difficulty of desirable shaping. When two or more structural members are produced separately and they are bonded each other to a final product, it becomes practicable to produce such a product which is difficult to form directly due to its shape. Further, if simple-shaped structural members are bonded each other, since both processing steps and shaping amount are reduced, cost reduction is realized.

In view of the above circumstances, a technique for bonding sintered blocks of low thermal expansion, high rigidity and high specific rigidity such as cordierite and lithium aluminosilicate has come to be in demand.

In a conventional method for providing such ceramics bonded body, after applying an inorganic adhesive such as solder, silver brazing alloy, glass and the like or an organic adhesive such as epoxy resin on at least one of bonding surfaces of the structural members, the bonding surfaces are set opposed, mutually pressed and heated to a predetermined temperature (see, for instance, Document 4: JP5-4876A).

However, since the inorganic adhesive and organic adhesive conventionally used as the bonding materiel are not low-thermal-expansion material, bonding strength is significantly impaired resulting from the residual stress caused by difference in thermal expansion coefficients between the low-thermal-expansion ceramics sintered block (base material) and the bonded portion. In some serious instances, a crack occurs on the bonded interface. Further, since the rigidity of the adhesive is low, the rigidity of the entire structural member after being bonded is lowered.

In order to solve the above disadvantages, it is proposed to use a bonding material primarily containing a low-thermal-expansion material such as cordierite, lithium aluminosilicate und the like, thereby reducing the residual stress generated on account of difference in thermal expansion coefficients between the base material and the bonded portion and providing a bonded body having high bonding strength.

For instance, Document 5 (JP2000-103687) employs a bonding composition containing 10 to 80 wt % of spodumene powder (particle size below 1.0 mm), 6 to 17 wt % of silica powder (particle size between 0.1 and 1.0 mm) and 10 to 80 wt % of cordierite aggregate (particle size between 0.01 and 1.0 mm) as bonding material.

Document 6 teaches the use of a mixture of 1 to 20 mass % of at least one compound selected from group III elements in the periodic table and 80 to 99 mass % of cordierite powder as bonding material.

Document 7 (JP2005-35839A) employs a composite material of lithium aluminosilicate, nitride and magnesium oxide that exhibits melting point lower than a base material of low-thermal-expansion ceramics and average thermal expansion coefficient between −1*10⁻⁶ and 1*10⁶/K (within 20 to 30° C. range).

However, though the residual stress is reduced to a degree by the above methods on account of reduction in the difference in thermal expansion coefficients between the base material and the bonded portion, since the bonded portion is made of a material different from the base material, not a little residual stress is generated.

Since the residual stress is magnified in accordance with the bonding area, the residual stress amounts to nonnegligible degree in a large member such as a structural framework, which causes decrease in rigidity of the entire structural member and bonding strength, and temporal change of structural member configuration.

Further, when the bonded body is shaped by grinding and the like, it is likely to be damaged during the shaping due to the residual stress and suffers from very low yield.

Further, since a process for applying the bonding material required when the above bonding material is used, production process becomes complicated, which is not desirable in terms of industrial productivity and economic efficiency.

Alternative bonding method under study is an application of hot pressing (HP) or hot isostatic pressing (HIP) suitable for metal-metal or metal-ceramics bonding into ceramics-ceramics bonding. The Studies are headed by C. Scoff et al. One example of the study can be found, in Document 8 (JP5-97530A) in Japan, which might be applied in the field of bonding low-thermal-expansion materials (an objective of the present invention).

However, the inner diameter of an ordinary HP or HIP equipment is approximately 300 to 400 mm, so that the size of products is limited within the inner diameter of HP or HIP itself. Larger structural members than the inner diameter of HP or HIP equipment are demanded for production units and measurement units of semiconductors, magnetic heads and the like, so the applicable products made by HP or HIP are strictly limited.

In contrast to the above method in which sintered blocks are bonded with each other, another bonding method applying a fresh molding body before sintering is well known. In this method (named Nota-Duke, Nuta-Duke or Tomo-Duke in Japanese), slurry as a binder, which is a precursor of molding piece, i.e. pre-molding mixture, is applied to bind fresh molded pieces with each other obtained by casting.

However, since Nota-Duke method (bonding a molding body to a molding body) employs molding bodies prepared by casting, the shape of the product is limited to the range applicable to casting. Therefore, the method is inconvenient to the application for the purpose of the present invention.

As described above, neither a bonded low-thermal-expansion ceramics body which has sufficient bonding strength to above-mentioned application and exhibits low thermal expansion, high rigidity, high specific rigidity that are applicable to a structural framework for a precision apparatus at a low cost, nor a manufacturing method for such a bonded ceramics body has not been obtained so far.

SUMMARY OF THE INVENTION

A primary object of the present invention is to provide a low-thermal-expansion ceramics bonded body capable of being manufactured at a low cost, having sufficient bonding strength for practical use, and exhibiting low thermal expansion, high rigidity and high specific rigidity, and manufacturing method thereof.

A low-thermal-expansion ceramics bonded body of an aspect of the present invention includes: a plurality of structural members of cordierite crystalline sintered block that shows absolute value of thermal expansion coefficient of 0.6*10⁻⁶/K or less in room temperature, modulus of elasticity (Young's modulus) of 100 GPa or more and specific rigidity (Young's modulus/bulk density) of 40 GPa·cm³/g or more; bonding surfaces of the plurality of structural members being brought into contact with each other and unified by a heating process, in which the cordierite crystalline sintered block contains 51.5 to 70.0 oxide-equivalent mass % of Si, the oxide-equivalent mass % being calculated as a ratio of Si in elements (Mg, Al and Si) constituting the sintered block on oxide (MgO, Al₂O₃, SiO₂) basis and the material constituting a bonded portion of the plurality of structural members is substantially the same as the base material.

In the low-thermal-expansion ceramics bonded body of the above aspect of the present invention, the cordierite crystalline sintered block preferably contains 8.0 to 17.2 oxide-equivalent mass % of Mg, and the cordierite crystalline sintered block preferably contains 22.0 to 38.0 oxide-equivalent mass % of Al, the oxide-equivalent mass % being calculated as a ratio of Mg or Al in elements (Mg, Al and Si) constituting the sintered block on oxide (MgO, Al₂O₃, SiO₂) basis.

In the low-thermal-expansion ceramics bonded body of the above aspect of the present invention, the cordierite crystalline sintered block preferably contains 0.1 to 2.5 oxide-equivalent mass % of Li.

In the low-thermal-expansion ceramics bonded body of the above aspect of the present invention, the cordierite crystalline sintered block preferably contains 0.1 to 10 oxide-equivalent mass % of one or more rare-earth elements including Y.

In the low-thermal-expansion ceramics bonded body of the above aspect of the present invention, the cordierite crystalline sintered block preferably contains 2 or less oxide-equivalent mass % of one or more transition metal elements.

In the low-thermal-expansion ceramics bonded body of the above aspect of the present invention, the bonding strength of the plurality of structural members is preferably 60% or more of the strength of the cordierite crystalline sintered block.

According to the low-thermal-expansion ceramics bonded body of the above aspect of the present invention, since the cordierite crystalline sintered block contains 51.5 to 70.0 oxide-equivalent mass % of Si, the oxide-equivalent mass % being calculated as a ratio of Si in elements (Mg, Al and Si) constituting the sintered block on oxide (MgO, Al₂O₃, SiO₂) basis, the reaction (mass transfer) of the sintered block during the heating process can be activated. Accordingly, a bonded body having very high bonding strength can be provided without employing bonding material. As a result, the material of the bonded portion can be made substantially the same as the base material, so that residual stress resulting from the difference in the thermal expansion coefficients of the base material and the bonded portion no longer exists. Thus, a low-thermal-expansion ceramics bonded body having extremely high bonding strength and bonding reliability can be provided at a low cost.

As described above, the present invention is extremely useful in industry.

A manufacturing method of a low-thermal-expansion ceramics bonded body of the present invention is for producing a low-thermal-expansion ceramics bonded body that includes: a plurality of structural members of cordierite crystalline sintered block that shows absolute value of thermal expansion coefficient of 0.6*10⁻⁶/K or less in room temperature, modulus of elasticity (Young's modulus) of 100 GPa or more and specific rigidity (Young's modulus/bulk density) of 400 GPa·cm³/g or more; bonding surfaces of the plurality of structural members being brought into contact with each other and unified by a heating process, in which the cordierite crystalline sintered block contains 51.5 to 70.0 oxide-equivalent mass % of Si, the oxide-equivalently mass % being calculated as a ratio of Si in elements (Mg, Al and Si) constituting the sintered block on oxide (MgO, Al₂O₃, SiO₂) basis and the heating process is conducted at a temperature between 1200 to 1500° C.

During the heating process in the method of manufacturing a low-thermal-expansion ceramics bonded body, 0.5 kPa or more pressure is preferably applied to at least a part of the bonding surfaces.

According to the manufacturing method of a low-thermal-expansion ceramics bonded body according to the above aspect of the present invention, the above-mentioned low-thermal-expansion ceramics bonded body of the present invention can be appropriately manufactured.

### BRIEF DESCRIPTION OF THE DRAWINGS

FIG. 1 is an image observed by scanning electron microscope showing a mirror-polished sample of a bonded body according to embodiment 2 of exemplary embodiments of the present invention;

FIG. 2 is another image observed by scanning electron microscope showing a sample of bonded body according to embodiment 10 that is etched by 46% of HF after being mirror-polished;

FIG. 3 is a table showing manufacturing conditions of the embodiments and comparisons; and

FIG. 4 is a table showing evaluation results of the embodiments and comparisons.

DETAILED DESCRIPTION OF PREFERRED EMBODIMENT(S)

An embodiment of the present invention will be described below. However, it should be understood that the scope of the present invention is not limited to the following embodiments but includes modifications and improvements based on the knowledge of skilled person in the art as long as an object of the present invention can be achieved.

The low-thermal-expansion ceramics bonded body of the present invention includes: a plurality of structural members of cordierite crystalline sintered block that shows absolute value of thermal expansion coefficient (in room temperature) of 0.6*10⁻⁶/K or leas, modulus of elasticity (Young's modulus) of 100 GPa or more and specific rigidity (Young's modulus/bulk density) of 400 GPa·cm³/g or more; and bonded portions of the plurality of structural members being structured by substantially the same material as the base material. Here, it should be noted that the cordierite crystalline sintered block contains 51.5 to 70.0 oxide-equivalent mass % of Si, the oxide-equivalent mass % being calculated as a ratio of Si in elements (Mg, Al and Si) constituting the sintered block on oxide (MgO, Al₂O₃, SiO₂) basis.

The above content (the unit thereof will be represented as equivalent mass % hereinafter) of Si is calculated as SiO₂/(MgO+Al₂O₃+SiO₂) supposing that the elements constituting the cordierite crystalline sintered block (Mg, Al, Si) exist as oxides (MgO, Al₂O₃, SiO₂) thereof.

In the present invention, the content of SiO₂ component in the sintered block is 51.5 to 70.0 equivalent mass %. Since the content is greater than 51.36 mass % (stoichiometric composition of cordierite crystalline phase), surplus SiO₂ component that is not solid-soluble in the cordierite crystalline phase is present as intergranular phase other than the cordierite crystalline grain. Since the surplus SiO₂ produces liquid phase at a relatively low temperature during heating process for bonding, the reaction (mass transfer) in the sintered block is activated, so that a bonded body with high adhesion strength can be provided without employing a bonding material. As a result, the material of the bonded portion becomes substantially the same as the base material and no residual stress on account of difference in thermal expansion coefficient between the base material and the bonded portion is generated. Accordingly, the obtained bonded body exhibits extremely high bonding strength and bonding reliability can be enhanced.

However, if excessive amount of surplus SiO₂ is present, bubbling phenomenon occurs during heating process and decrease in density and rigidity of the sintered block is resulted. Accordingly, the content of SiO₂ in the sintered block is preferably 70.0 equivalent mass % or less.

In the present invention, the bonded portion refers to an area of approximately 100 μm width around an interface at which the bonding surfaces of a plurality of structural members are in contact with each other. The bonded portion may be constructed in any manner as long as the material is substantially the same as the base material, where approximately 1 to 50 μm pores may be contained as long as the bonding strength is not affected.

The surplus SiO₂ in the sintered block may be either amorphous or crystalline. However, at least a part thereof may preferably be crystalline for high rigidity and, in contrast, preferably be amorphous for low thermal expansion.

With regard to the thermal expansion coefficient of the sintered block, in order to maintain stability of dimension accuracy necessary for recent production unit of highly integrated semiconductors, miniaturized magnetic heads and the like, the absolute value of the thermal expansion coefficient in room temperature must be 0.6*10⁻⁶/K or less. Further, a thermal expansion coefficient of nearly zero expansion is necessary for precision apparatus requiring highly accurate thermal stability, so that it is preferable that the absolute value of the thermal expansion coefficient of the sintered block in room temperature is 0.3*10⁻⁶/K or less.

The room temperature refers to a temperature range between 20 and 25° C. and all of the “room temperature” in the present description refers to the above temperature range.

100 GPa or more of Young's modulus is required for the sintered block to be used as a precision structure within a predetermined space, which more preferably is 120 GPa or more. When Young's modulus becomes lower than 100 GPa, the structure block has to be thickened and the size thereof has to be increased, which is not preferable in terms of weight-reduction.

In addition, in order to adjust the precision device to further increase in size and moving speed, the specific rigidity of the sintered block has to be set large. In the present invention, specific rigidity of 40 GPa·cm³/g or more is required, which preferably is 50 GPa·cm³/g or more.

Further, the cordierite crystalline sintered block contains 8.0 to 17.2 oxide-equivalent mass % of Mg, the oxide-equivalent mass % being calculated as a ratio of Mg in element (Mg, Al and Si) constituting the sintered block on oxide (MgO, Al₂O₃, SiO₂) basis. Further, the cordierite crystalline sintered block contains 22.0 to 38.0 oxide-equivalent mass % of Al, the oxide-equivalent mass % being calculated as a ratio of Al in elements (Mg, Al and Si) constituting the sintered block on oxide (MgO, Al₂O₃, SiO₂) basis.

The above Mg content (the unit thereof will be represented as equivalent mass % hereinafter) is calculated as MgO/(MgO+Al₂O₃+SiO₂) supposing that the elements constituting the cordierite crystalline sintered block (Mg, Al, Si) exist as oxides (MgO, Al₂O₃, SiO₂). In the same manner, the above Al content (the unit thereof will be represented as equivalent mass % hereinafter) is calculated as Al₂O₃/(MgO+Al₂O₃+SiO₂).

The stoichiometric composition of cordierite crystal is [MgO: 13.78 mass %, Al₂O₃: 34.86 mass %; SiO₂: 51.36 mass %], where it is known that solubility range within the three-component system is extremely narrow. Accordingly, the deviation of elemental ratio of MgO, Al₂O₃ and SiO₂ components results in generation of a phase other than cordierite crystalline phase.

In the present invention, it is considered that MgO and Al₂O₃ components existing in a form other than the cordierite crystalline phase is soluble in an intergranular phase primarily containing the above-described surplus SiO₂ or exist in other crystalline phase such as spinel (MgO.Al₂O₃). If the elemental ratio of MgO and Al₂O₃ components is within the range defined in the present invention, at least a part of MgO and Al₂O₃ components existing in a form other than cordierite crystalline phase is soluble in the intergranular phase primarily containing the surplus SiO₂, so that liquid phase can be provided at a low temperature during the heating process, thereby enhancing the bonding strength.

However, when the content of MgO is greater than 17.2 equivalent mass % and/or the content of Al₂O₃ is greater than 38.0 equivalent mass %, the generation of other crystalline phase such as spinel and the like increases, which is undesirable in view of increase in thermal expansion coefficient.

When the content of MgO is lower than 8.0 equivalent mass % and/or the content of Al₂O₃ is lower than 22.0 equivalent mass %, relative SiO₂content becomes excessive, which results in bubbling phenomenon during the heating process and decrease in the density and rigidity of the sintered block and therefore is undesirable.

Further, the above cordierite crystalline sintered block preferably contains 0.1 to 2.5 oxide-equivalent mass % of Li (mass % of Li₂O in the entire sintered block).

Li is generally known as a glass former that considerably lowers the melting point of Li—Si—O based glass and the like. In the present invention, since at least a part of Li is soluble in the intergranular phase primarily containing SiO₂ to form a liquid phase at a low temperature during heating process, a bonded body with higher bonding strength can be provided. The oxide equivalent content of Li is preferably 0.1 mass % or more in order to gain the advantage of Li. Especially, when the content is between 0.2 and 1.0 mass %, a structural member of extremely low (absolute value of 0.1*10⁻⁶/K or less) thermal expansion coefficient can be advantageously obtained. On the other hand, Li contents exceeding 2.5 mass % is not preferable since the decrease in modulus of elasticity becomes prominent.

One or more rare-earth element including Y also activates the reaction in the sintered block in the same manner as Li, which serves for further enhancement of the bonding strength.

In order to gain the effect of the rare-earth element, 0.1 to 10 oxide-equivalent mass % (i.e. mass % of rare-earth element oxide in the entire sintered block) of rare-earth element is preferably contained. Especially, when the content is 1.0 to 5.0 mass %, a structural member of extremely low (absolute value of 0.1*10⁻⁶/K or less) thermal expansion coefficient can be advantageously obtained.

Rare-earth element such au Y, La, Ca, Pr, Nd, Pm, Sm, Eu, Gd, Tb, Dy, Ho, Er, Tm, Yb and Lu may preferably be used. Above all, Y is preferable in terms of availability and cost.

In the present invention, the cordierite crystalline sintered block preferably contains 2 or less oxide-equivalent mass % of one or more transition metal element (mass % of transition metal element oxide in the entire sintered block).

At least a part of the above transition metal element is soluble in the intergranular phase primarily containing surplus SiO₂ to form a liquid phase at a low temperature during heating process, so that the reaction in the sintered block is further promoted and the bonding strength can be further enhanced.

More than 2 oxide-equivalent mass % content of transition metal element causes bubbling phenomenon and decrease in density and rigidity, so it is not preferable.

The transition metal element that is the most advantageously used in the present invention is the first transition metal element such as Cr, Mn, Fe, Co, Ni and Cu.

Here, it is sufficient that at least a part of the content of Li, rare-earth element and transition metal element is soluble in the intergranular phase primarily containing surplus SiO₂, where Li, rare-earth element and transition metal element are allowed to exist as a compound crystal such as oxide, nitride, carbide and boride as long as thermal expansion coefficient is not influenced.

The oxide may be: a single oxide of Li, rare-earth element and transition metal element; or a composite oxide containing at least one of MgO, Al₂O₃ and SiO₂ and at least one of Li, rare-earth element and transition metal element.

In the present invention, the bonding strength between plural pieces made of the above cordierite crystalline sintered block is preferably 60% or more, more preferably 70% or more of the strength of the cordierite crystalline sintered block itself as base material.

Accordingly, a low-thermal-expansion ceramics bonded body with high rigidity of whole structure after bonding and with high bonding reliability can be provided.

Next, the method of manufacturing low-thermal-expansion ceramics bonded bodies of the present invention is described as follows.

After polishing the bonding surface of the above-mentioned two or more sintered blocks, heating process is applied while bringing the polished surfaces into contact with each other. The heating temperature is preferably between 1200 and 1500° C., mote preferably between 1275 and 1450° C. When the healing temperature is lower than 1200° C., the reaction in the sintered block does not sufficiently progress, which decreases the bonding strength. In contrast, when the heating temperature is higher than 1500° C., the cordierite crystal is decomposed and the bonding strength is lowered. The heating process can be conducted in the air or in a nonoxidative atmosphere such as hydrogen, nitrogen and argon under pressureless condition or, as desired, under pressurized condition such us gas-pressure sintering (GPS), hot press sintering (HP) and hot isostatic press sintering (HIP) and the like.

In the present invention, it is especially preferable to apply 0.5 kPa or more, preferably 3 kPa or more, more preferably 7 kPa or more of pressure on at least a part of the bonding surfaces during the heating process. Accordingly, bonding strength can be enhanced.

Specific embodiments of the present invention are described in detail as follows, however, it should be appreciated that the scope of the present invention is not limited to the embodiments.

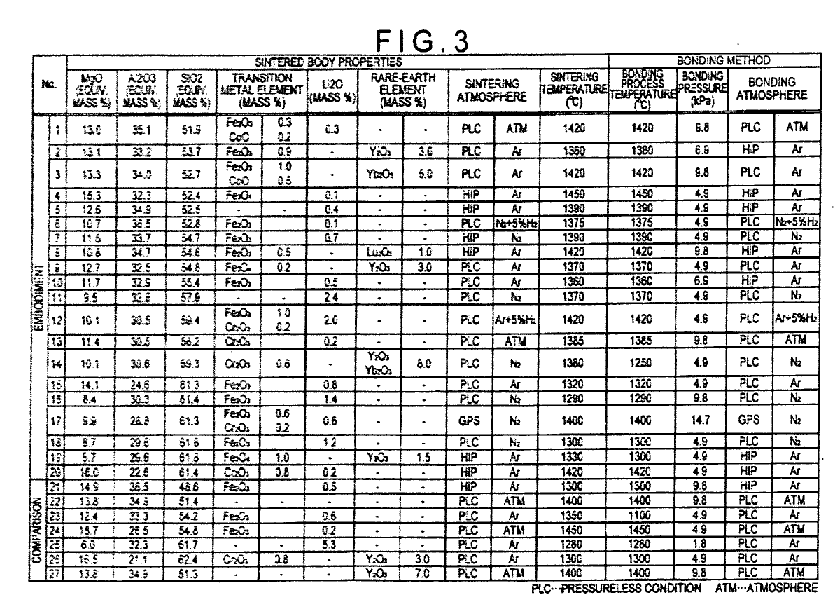

Samples Nos. 1 to 20 were prepared as the embodiments of the present invention (embodiments 1 to 20) and samples Nos. 21 to 27 were prepared for comparative purpose (comparisons 21 to 27). The manufacturing conditions of the respective samples are shown in FIG. 3. Manufacturing steps of the respective samples is described as follows.

Magnesia (mean particle size 0.2 μm), cordierite (mean particle size 3 μm), magnesium hydrate (mean particle size 1 μm), lithium carbonate (mean particle size 2 μm), β-spodumene (mean particle size 2 μm), eucryptite (mean particle size 2 μm), silica (molten silica: mean particle size 0.7 μm) and alumina (mean particle size 0.3 μm) were used as raw material powder. The material of the transition metal element and rare-earth element were oxide of the respective elements (mean particle size 1 μm).

After the materials were blended to be the chemical composition shown in FIG. 3, 3 mass % of resin binder was added and mixed inside an alumina pot using water for twenty-four hours. The obtained slurry was dried and granulated, which is formed under hydrostatic pressure of 1.0 ton/cm². The obtained green body was heated up to 500° C. in the air for burnout of the resin binder.

The green body after binder burnout was sintered according to sintering method, atmosphere and temperature shown in FIG. 3. The green body was sintered under surface-pressure of 400 MPa in HP, under gas-pressure of 0.5 MPa in GPS and under 152 MPa at 1300° C. in HIP after pressureless sintering. The sintering time was four hours in the pressureless sintering and GPS while an hour in HP and HIP.

FIG. 3 shows the content of the respective components in the respective samples measured according to the following methods.

(Mg, Al, Si content) Measured by X-ray fluorescence analysis using calibration curve calculated by a known synthetic sample. FIG. 3 shows respective equivalent mass % of MgO, Al₂O₃ and SiO₂.

(Content of other components) Measured according to inductively-coupled plasma spectrometry (ICP). FIG. 3 also shows a mass % of respective oxides in the cordierite crystalline sintered block.

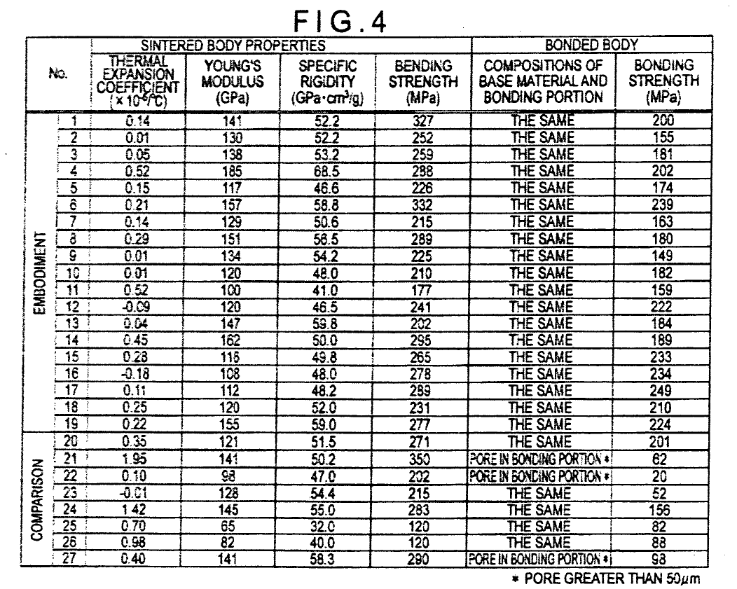

Following evaluations were conducted on the respective samples obtained as in the above. The results are shown in FIG. 4.

(Thermal Expansion Coefficient) Since the thermal expansion coefficient in room temperature requires precise measurement, the thermal expansion coefficient was measured according to JIS-R-3251 (double-pass Michelson laser-interference method) for measuring thermal expansion coefficient of low-thermal expansion glass.

(Young's modulus) Measured according to ultrasonic pulse method (JIS-R-1602).

(Specific rigidity) Measured by dividing the value of Young's modulus by density measured according to Archimedes' method (JIS-R-1634).

(Bending strength) Four-point bending test strength according to JIS-R-1601 was measured.

Next, the sintered block was formed in a cube of 30 mm on a side to prepare structural members. The bonding surfaces of the structural members were brought into contact with each other and were heated for two hours under the conditions shown in FIG. 3. The content of the respective components in the obtained bonded bodies was evaluated according to the same method as the sintered blocks and it was confirmed that there was no difference between the bonded bodies and the sintered blocks. Further, following evaluations were conducted on the obtained bonded bodies.

(Observation of structure of the bonded portion) The surface textures of the bonded portion of mirror-polished samples and samples etched by 46% of HF after being mirror-polished were analyzed by scanning electron microscope (SEM).

(Bonding strength) Bending test pieces having dimensions of 3 mm*4 mm*45 mm were cut from bonded bodies so that the bonded portion was located at the longitudinal center thereof. Next, room-temperature bending strength of the samples was measured by four-point bending test conducted according to JIS-R-1601 while the bonded portion was located at the center of supporting points, which was evaluated as the bonding strength.

In FIG. 4, Nos. 1 to 20 exhibit the results of the embodiments of the present invention, where all of the samples show excellent results.

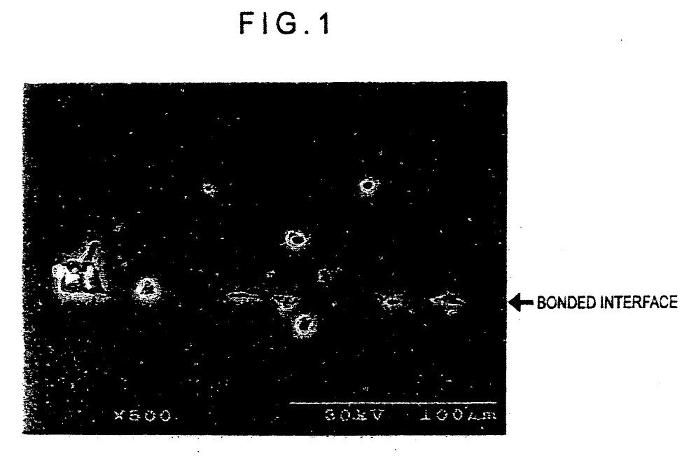

Observation results of the structure of the bonded portion (mirror-polished sample) of the embodiment shown in No. 2 (embodiment 2) are shown in FIG. 1. As shown in FIG. 1, though the bonded portion contains pores of 50 μm or less, the material composition is substantially the same as the base material and the bonding strength is within the range of the present invention.

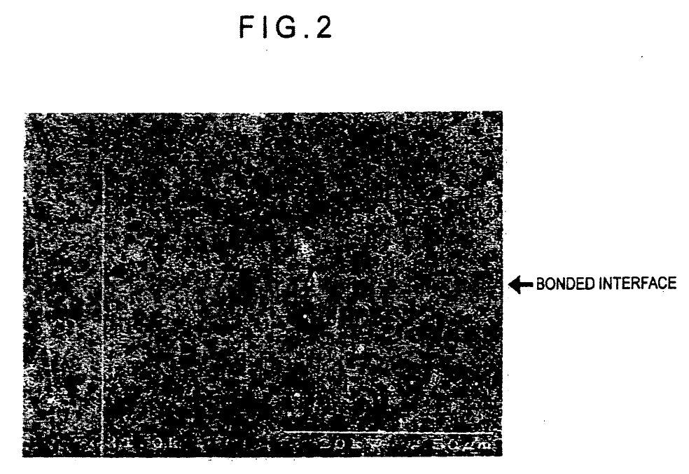

Observation results of the structure of the bonded portion (a sample etched by 46% of HF after being mirror-polished) of the embodiment shown in No. 10 (embodiment 10) are shown in FIG. 2. It is recognized on FIG. 2 that the material of the bonded portion is substantially the same as the base material.

In FIG. 4, Nos. 21 to 27 represent comparisons of the present invention.

The SiO₂content of No. 21 sample was outside the range of the present invention, so that the thermal expansion coefficient and bonding strength were outside the scope of the present invention.

Since the chemical composition of No. 22 sample was substantially the same as stoichiometric composition of cordierite crystalline phase and contained no transition metal element, Li₂O and rare-earth element, Young's modulus and bonding strength were outside the scope of the present invention.

Since the bonding-process temperature of No. 23 sample was below the lower limit of the present invention, the bonding strength was outside the scope of the present invention.

The MgO content of No. 24 sample was outside the range of the present invention, so that the thermal expansion coefficient and bonding strength were outside the scope of the present invention.

The MgO and Li₂O contents of No. 25 sample were outside the range of the present invention, so that the thermal expansion coefficient, Young's modulus and specific rigidity were outside the scope of the present invention.

The Al₂O₃ content of No. 26 sample was outside the range of the present invention, so that the thermal expansion coefficient and Young's modulus were outside the scope of the present invention.

Though rare-earth element content of No. 27 sample was within the scope of the present invention, elemental ratio of MgO, Al₂O₃ and SiO₂ component was substantially the same as stoichiometric composition of cordierite crystalline phase, which was obtained by bonding method of sintered blocks disclosed in the Document 6 that was outside the scope of the present invention. Consequently, the bonding strength was considerably outside the scope of the present invention.

The priority application Number JP 2006-176966 upon which this patent application is based is hereby incorporated by reference.

What is claimed is:

1. A low-thermal-expansion ceramics bonded body obtained by unifying a plurality of structural members composed of cordierite crystalline sintered block exhibiting 0.6*10⁻⁶/K or less of absolute value of thermal expansion coefficient in room temperature, 100 GPa or more of modulus of elasticity (Young's modulus) and 40 GPa·cm³/g or more of specific rigidity (Young's modulus/bulk density), the plurality of structural members having bonding surfaces that are brought into contact with each other and are unified by a heating process,
wherein the cordierite crystalline sintered block contains 51.5 to 70.0 oxide-equivalent mass % of Si, the oxide-equivalent mass % being calculated as a ratio of Si in elements (Mg, Al and Si) constituting the sintered block on oxide (MgO, Al₂O₃, SiO₂) basis, and
a material constituting a bonded portion between the plurality of structural members is substantially the same as a base material of the plurality of structural members.

2. The low-thermal-expansion ceramics bonded body according to claim 1,
wherein the cordierite crystalline sintered block contains 8.0 to 17.2 oxide-equivalent mass % of Mg, the oxide-equivalent mass % being calculated as a ratio of Mg in elements (Mg, Al and Si) constituting the sintered block on oxide (MgO, Al₂O₃, SiO₂) basis, and
the cordierite crystalline sintered block contains 22.0 to 38.0 oxide-equivalent mass % of Al, the oxide-equivalent mass % being calculated as a ratio of Al in elements (Mg, Al and Si) constituting the sintered block on oxide (MgO, Al₂O₃, SiO₂) basis.

3. The low-thermal-expansion ceramics bonded body according to claim 1,
wherein the cordierite crystalline sintered block contains 0.1 to 2.5 oxide-equivalent mass % of Li.

4. The low-thermal-expansion ceramics bonded body according to claim 1,
wherein the cordierite crystalline sintered block contains 0.1 to 10 oxide-equivalent mass % of one or more rare-earth elements including Y.

5. The low-thermal-expansion ceramics bonded body according to claim 1,
wherein the cordierite crystalline sintered block contains 2 or less oxide-equivalent mass % of one or more transition metal elements.

6. The low-thermal-expansion ceramics bonded body according to claim 1,
wherein the bonding strength of the plurality of structural members is 60% or more of the strength of the cordierite crystalline sintered block.

7. A manufacturing method of a low-thermal-expansion ceramics bonded body, comprising the steps of:
providing a plurality of structural members exhibiting 0.6*10⁻⁶/K or less of absolute value of thermal expansion coefficient in room temperature, 100 GPa or more of modulus of elasticity (Young's modulus) and 40 GPa·cm ³/g or more of specific rigidity (Young's modulus bulk density);
bringing bonding surfaces of the plurality of structural members into contact with each other; and
unifying the bonding surfaces by a heating process,
wherein the cordierite crystalline sintered block contains 51.5 to 70.0 oxide-equivalent mass % of Si, the oxide-equivalent mass % being calculated as a ratio of Si in elements (Mg, Al and Si) constituting the sintered block on oxide (MgO, Al₂O₃, SiO₂) basis, and
the heating process is conducted under temperature between 1200 and 1500° C.

8. The manufacturing method of low-thermal-expansion ceramics bonded body according to claim 7,
wherein 0.5 kPa or more of pressure is applied to at least a part of the bonding surfaces during the heating process.
